(19) United States
(12) Patent Application Publication
(10) Pub. No.: US 2017/0060343 A1
(43) Pub. Date: Mar. 2, 2017

(54) FIELD ANALYSIS FOR FLEXIBLE COMPUTER INPUTS

(71) Applicant: Ralf TRACHTE, AARAU (CH)

(72) Inventor: Ralf TRACHTE, AARAU (CH)

(21) Appl. No.: 15/348,229

(22) Filed: Nov. 10, 2016

Related U.S. Application Data
(63) Continuation of application No. 14/307,555, filed on Jun. 18, 2014.
Application No. 14/307,555 is a continuation of application No. PCT/CH2012/000275, filed on Dec. 18, 2012.

(30) Foreign Application Priority Data
Dec. 19, 2011 (CH) 2005/11

(51) Int. Cl. G06F 3/041; B62D 1/04; G06F 3/044; G06F 3/0354; G06F 3/02

(52) U.S. Cl. CPC G06F 3/0418; G06F 3/03547; G06F 3/02; G06F 3/044; B62D 1/046; G06F 2203/04104; B60K 35/00

(57) ABSTRACT

Field analyses for flexible computer inputs are methods for analyzing contact or multi-touch events, specifically to update a system of input elements, e.g. the arrangement of virtual keys or touch zones or gesture-based systems. A field of vectors, which may also include potential values, or evaluation factors, is assigned to the input surface. A sequence and linking of process steps includes the evaluation of these data, produces them in fields that denominate the displacements of the input elements and can be combined with evaluations and case distinctions. Crosslinks are taken into consideration that contain corresponding priority structures depending on use category. Optimizations are thereby possible. In particular, in the case of the touch-sensitive steering wheel, the method includes specific hand or finger surfaces, (for instance through pattern recognition) and categories of gripping or touching; gesture-based controls (“gesture”) and a coordinated use of the display are possible.

### CROSS-REFERENCE TO RELATED APPLICATIONS

The present application is a continuation of pending U.S. application Ser. No. 14/307,555, filed Jun. 18, 2014, which is a continuation of International patent application PCT/CH2012/000275, filed Dec. 18, 2012 designating the United States, which international patent application has been published in German language and claims priority from Swiss patent application 2005/11, filed Dec. 19, 2011. The entire contents of these prior applications are incorporated herein by reference.

### BACKGROUND OF THE INVENTION

In adaptive keyboards—such as keyboards on touch screens or other buttons variable in their position or shape (“input elements”) on touch-sensitive surfaces—the question arises in which way the deviation of the contact (or approach) made is to be evaluated compared with the currently valid “ideal” position (of an “input element”): Should the difference recognized each time actually be adopted as a change? Should it be regarded simply as an outlier? Or should it have a further effect on the entire arrangement?—Possibilities are proposed here for detecting, analyzing and evaluating touch events (meaning contacts or specific approaches) and their inclusion in the updated calculation of a system of input elements (in particular re-calculation of the arrangement of virtual keys).

Evaluable data can be determined (A) based on a multi-touch input, meaning through simultaneous contact (or approach) of several hand or finger surfaces or (B) based on individual contacts (or approaches) performed in a chronological sequence, or based on the combination of (A) and (B).

A particular vector is assigned to a particular input surface area, which, expressed in a simplified way, can also serve as an input element like a virtual key and which in particular can be represented as a currently ideal key center,—or optionally assigned to each point of the input surface—, said vector including at least two dimensions (and can also include a third dimension), whereby in particular intended displacements, or those to be performed finally (of the respective input element), are described. In addition, a particular vector of this kind can also include potential values or evaluation potential values or evaluation parameters. (At least) one currently valid, multi-dimensional field of vectors is to be assigned to the input surface that also includes potential values where applicable.—These methods also provide interaction on a steering wheel.

BRIEF SUMMARY OF THE INVENTION

As a whole, the method explained here is characterized by a sequence and networking of process steps that comprise: field analyses (i.e. collecting and evaluating multi-dimensional data from the input surface areas actuated, refined into three types of vector fields (“primary, secondary, tertiary”) that contain data about displacement vectors for the input elements and that can be combined with diverse evaluations that can similarly be represented as fields, combined with cross-linkings that are controlled—depending on the use category—by an assumed field of priority structures for the input elements. The input elements correspond to virtual keys or touch zones that are temporarily assigned to specific input surface areas.

In other words, it is a method for operating a computer input device, having a touch-sensitive or approach-sensitive input surface with a plurality of input surface areas or approach areas and a control unit that is coupled to the input surface, wherein a character, specifically a letter, a number or other control character, is assigned to a specific input surface area or approach area and is thus represented as an input element within a system of input elements, characterized in that contacts with or approaches to the input surface are identified in their deviation relative to the currently valid arrangement of input elements and described as at least a respective vector—“primary vector”—or as a vector field—“primary vector field”—and analyzed and evaluated in a first process step, and thus initially only planned particular displacements of the input elements, described as a field of vectors—“secondary vector field”—, are calculated, a particular additional value or an additional field, in particular a potential field or vector field, is ascribed to the input surface or to the aforesaid vectors ascribed to particular input elements, said field representing analysis or evaluations or conclusions, and a priority structure between the different input elements is used, following further analyses, evaluations and optimizations, to actually perform in a further process step the optimized displacements, which are writeable as a vector field—“tertiary vector field”—of the particular input elements.

This means, based on the contacts or approaches, optimized, complex changes in the arrangement of input elements must be calculated. The method combines field analyses and priority structures, observes a vector cluster cross-linking of input elements (specific clusters, or groups, of input elements are cross-linked, or linked, to each other across different dimensions of the assigned vectors), and allows vector field trend analyses (trends in the displacements or evaluations are described in the vector field).

Links, coupling factors and evaluations are performed according to the element first considered affected, and the cross-links of the “clusters” of input elements follow specific priority rules (vector field cluster analysis with specific cross-linking with priority structure). The disclosure describes use cases and methods for a typing keyboard and for a multi-touch steering wheel.

### BRIEF DESCRIPTION OF THE DRAWINGS

FIG. 1 shows a part of the input elements of a keypad with the actuation of a second-rank input element in row 112 deviating from the center of the key, shown as a “primary” vector 132 (black arrow) and “secondary” vectors 141, 142, 143 (white arrows) calculated therefrom for the input elements affected because of the priority structure.

FIG. 2 shows the same as FIG. 1, supplemented by an example of a typical functional progress for the F-relevance factor depending on the distance of the contact from the ideal center of the key.

FIG. 3 shows a part of the input elements of a keypad with the actuation of a third-rank input element in row 113 deviating from the center of the key, shown as a “primary” vector 333 (black arrow) and “secondary” vectors 342, 343 (white arrows) calculated therefrom for the input elements affected because of the priority structure

FIG. 4 shows a part of the input elements of a keypad with the actuation of a first-rank input element deviating from the key center, shown as a “primary” vector 431 (black arrow) and “secondary” vectors as 441 calculated therefrom (white arrows) for the plurality of input elements affected because of the priority structure, wherein collision problems exist at the upper edge 115.

FIG. 5 shows as an example a steering wheel 500 with currently valid respective input elements 521, 522 . . . 528 assigned to the fingers to activate eight options that are shown in analog form in the display 550 and possible gesture-based controls by the thumbs (cross-hatched and black arrows) for scrolling the display image and for cursor control.

### DETAILED DESCRIPTION OF THE INVENTION

The input surface consists of a plurality of input surface areas, or approach areas (e.g. capacitive measurements, infra-red sensors or camera evaluations allow the detection of approaches). The input surface is, for example, a multi-touch screen, part of a mobile device for data communication (e.g. “smart phone,” mobile computer) or a touch-sensitive steering wheel. Specifically, a set of characters, e.g. letters, numbers or other control characters or signals is entered. A character is assigned in each case to a specific input surface area or approach area currently valid for it and thus represented as an input element within a system of input elements. The input elements within the system of input elements form a selectable arrangement with specific proximity relationships (in particular a computer keyboard or telephone key pad or keys arranged in a row or other arrangements of individual virtual keys in a specific relation to the fingertips or palms). Corresponding to the specific proximity relationships within the arrangement is a plurality of possible connections, cross-connections, cross-links as information about planned displacements and evaluations that can be used for the coordination and optimized calculation of displacements. Each input element can represent a shape and an ideal center (corresponds to a virtual key with an ideal key center) and be represented visually.

A sequence of field analyses is performed using the data about inputs and arrangements of input elements.

A contact (or where applicable, an approach that meets specific criteria to be evaluated as activation) is initially assigned to a nearby input element (generally because of the shortest distance). The contact (or approach), with its deviation relative to the currently valid position of the corresponding input element (or its ideal center), is writeable as a vector. In the event of several simultaneous contacts (or approaches), or in the event of the evaluation of several contacts (or approaches) considered within a specific period of time, the respective deviations relative to the currently valid arrangement of input elements are writeable as a field of vectors: “primary vector field.”

With the “primary” change of hand or finger positions ascertained on the basis of contacts (or approaches), a “secondary” change in the arrangement of input elements is initially calculated experimentally: The contacts with (or approaches to) the input surface are analyzed and evaluated in primary process steps. Initially only planned displacements in the input elements, writeable as a field of vectors, are calculated: “secondary vector field.”

A vector field assigns a particular vector to each input element. (In principle, such a vector can be assigned to each point of the input surface. It is also possible to work with a selection of important input elements that accurately represent the operation).

In addition, additional fields are attributed to the input surface or said vector fields, in particular potential fields or vector fields that represent specific analyses, evaluations (relevance, reliability or problems) corrections or conclusions determined by characteristics, potential values, factors or vectors. The latter can be included in certain steps of the method using factors.

In addition, priority structures between the different input elements are assigned to the input elements (and thus possibly also to the vector fields) that—depending on the category of contact, or use,—then link case distinctions (depending on primary activation) and rankings to selected calculation factors (for more details see below).

Based on the geometric arrangement of the system of input elements—depending on the category of contact, or use—in conjunction with the concrete use of the input (e.g. as keyboard, as switching zones on a steering wheel) there exist specific proximities, clusters, groupings (for instance, by reference to a particular finger) and cross-linkings of different aspects. Such relationships and cross-linkings can also be represented and calculated within vector fields.

Following further analyses, evaluations and optimizations, the optimized displacements of the respective input elements, described as “tertiary vector field,” can actually be performed in a further process step. (In theory, additional sets of steps can follow to achieve greater optimization: iterative approach).

In addition—specifically in the case of using a steering wheel—it can be expedient to set up a (“primary”) hand vector field and incorporate it into the method: From available information (e.g. through changes in a capacitive field and pattern recognition) about the three-dimensional position of the hand compared to the input surface, vectors here describe in each instance the change in an idealized point of the hand or finger surface. Beyond the fingertips, those are, for example, the areas of the inner surface of the hand where the fingers join (base of the thumb, base of the fingers) and fringe points of the hand inner surfaces. This means that each hand vector touches at specific points of the hand in three-dimensional space above the input surface and points in the direction of the current change. A precise description can additionally be possible, for example, by representing hand or finger joints with their respective angles in their link to the hand vector field. The aforesaid complete “primary” vector field can also be influenced or checked via this hand vector field. For example, the identity of a tapping finger can be determined in this way, allowing the “primary” vector field to be calculated more reliably. (In addition, certain influencing factors can be assigned to certain hand or finger areas via a hand potential field as a description of their particular relevance in the identification of hand positions.

The analysis of a vector field basically involves taking cross-linkings of different kinds into consideration, in particular identifying changes within proximate input elements and within groups (“clusters”) of input elements, meaning a vector cluster cross-linking that is additionally linked to a priority structure and to at least one additional field that represents additional evaluations (such as the relevance of a primary vector). The respective groups (“clusters”) of input elements analyzed in this way can be selected in different ways so that trends of partial fields or of particularly weighted cluster are identified (“vector cluster analysis”).

The field of a priority structure is integrated into the (primary or secondary) vector field: Each particular input element is to be assigned a (primary or secondary) vector that relates to the vectors of the other input elements via a network of links to be calculated by categories of variants of gripping (in the case of the steering wheel), by priorities, case distinctions and selectable factors, which network can be depicted by a field.

The input elements thus form a system, are networked with each other, in fact with respect to information about vectorially writeable displacements (using vectors) and with respect to evaluations (in particular regarding collisions of virtual keys or errors) and also with respect to a priority structure. Depending on the application or categorization identified, system-typical priority structures can be used between the different input elements.

The aforesaid planned secondary vector field is calculated from the aforesaid primary vector or the aforesaid primary vector field via a combination of field analyses or priority structures that contain case distinctions according to primarily activated input elements, sequences and describe respective links or cross-links between the different input elements.

The primary vector field is thus recalculated according to analyses and evaluations—in particular according to links in terms of the priority structure—and transmitted to the secondary vector field. The priority structure thus contains a networked structure about the type of transmission of a primary displacement using factors previously selected for setting system characteristics. The priority structure—in particular depending on the input element regarded as primarily affected or depending on the primary vector field, and in particular depending on additional case distinctions,—uses a set of selectable factors wherein these factors serve to calculate the planned secondary vector field and thus control the characteristics of the system of input elements. The priority structure makes case distinctions depending on primarily activated input elements and their rank within the system of input elements. It transmits a primary vector in a graduated way as a field of vectors to the secondary vector field, depending on identified case distinctions, sequences and previously preset factors and depending on a correct link between the elements.

The priority structure thus contains case distinctions, sequences, statements, and mathematical links that refer to the field of input elements and to the field of vectors and to this extent is itself writeable as a field. Depending on the particular application, or use category, relevant cross-links between the elements (via displacements or via information and evaluations that are writeable as a vector field or as a potential field) can be considered within the field of priority structures. Essentially, a field of priority structures can also be used in the calculation from the secondary to the tertiary vector field.

Preset use categories or those to be identified—e.g. on the steering wheel or on other input surfaces—are in particular simple switches, various keyboards and selectable arrangements with specific clusters and proximity relationships, telephone keypad, a number of keys in a row or individual virtual keys in a specific relation to fingertips or palms, an alphanumeric keyboard and gestural controls. To this extent particular priority structures and cross-links within the arrangement of input elements referring to each other are to be built up in different variants.

Tapping activation of input elements and gestures, meaning gesture-based displacement of input elements, are performed in quite rapid succession in actual use. On the one hand, the task presents itself of identifying the particular use category, which happens in coordination with the identifying and protocolling of the current hand position, and on the other hand of updating the system of input elements in their positions. Specific methods of use, meaning use categories and hand position categories, should be considered in the algorithms as case distinctions.

A priority structure in particular can be used for the process step from the primary vector (or from the primary vector field) to the secondary vector field, which makes case distinctions depending on the input element primarily regarded as affected and uses sequences of the input elements to relay the primarily determined displacement in a specific structured manner within the system of input elements in a graduated way. Basically, a (primary, secondary, tertiary) vector is assigned to each input element and said element is accorded a typical (within the system) role with respect to case distinctions and sequences. It involves a priority structure integrated into the vector field or a field of priority structures.

A priority structure integrated into the vector field can mean in addition that the input elements are (as stated) networked among each other, namely with respect to information using vectorially (using vectors) writeable displacements and collision or error evaluations as well with respect to a priority structure. (Expressed differently, information from the vector fields is evaluated with the aid of priority structures and in turn controls the vector fields.)

Specifically, to start with, the priority structure contains case distinctions about the rank of an input element regarded (primarily) as affected. A multi-stage (basically changeable) hierarchy of input elements (virtual keys) is assumed:

1. First-rank input elements influence very many, almost all or even all other displaceable input elements of the system (in particular all input elements of a particular hand). 2. Second-rank input elements influence one group (belonging to the same finger) of the input elements of a system. 3. Third-rank input elements do not influence any or only one or only individual proximate input elements. 4. Fourth-rank input elements are only influenced by other input elements.

Priority structure means in particular in the case of the alphanumeric keyboard (as a use category) there are:

1.) “First rank” input elements that correspond to the input elements of the basic row, meaning the basic position of 10-finger tapping. If a “first-rank” input element in row 101 is activated primarily (FIG. 4), then this primary vector 431 results in: a) the position of this element in terms of the vector 441 being massively altered, b) the positions of the other “first-rank” elements that correspond to the same basic row of the same hand also being massively altered, but specifically somewhat less than with a). Thus a relative change within the arrangement of the elements of the basic row is possible (e.g. the curvature of their alignment can change). c) the positions of the further, lower-order elements of this hand move as well (rather as in the case of b)) by maintaining their relative position over against the particular “first-rank” element of their “group” (those are the elements that are generally activated by a specific finger and, for example, form a column such as X,” “S,” “W,” “2”) to which group they are related as lower-order elements. (The key for “W,” for example, remains in a relatively identical relationship to the key for “S” and moves with it, even when one of the keys “A,” “D,” or “F” is activated and displaced.)

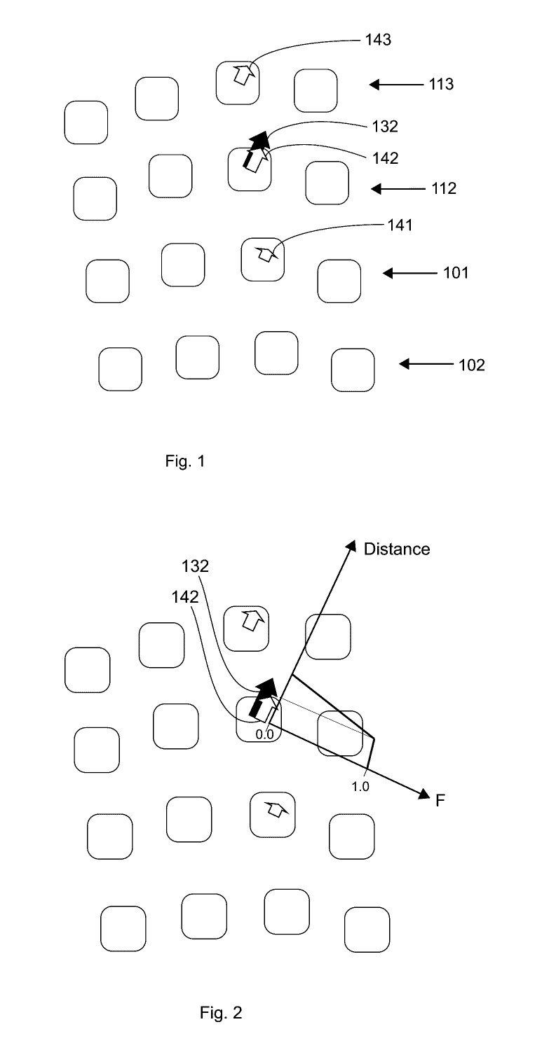

2.) “Second-rank” input elements are input elements (e.g. “0,” “W” . . . “X,” “C” . . .) in the rows 102 or 112 directly adjacent to the basic row. If a “second-rank” input element is activated primarily (FIG. 1), this primary vector 132 results in: a) the position of this element being clearly changed in terms of the vector 142, which is calculated as a change (secondary vector) over against the position of the next higher ranking element, meaning of the corresponding “first-rank” element (of the same group of the particular finger). b) no or only a relatively small change 141 is relayed initially to this next corresponding “first-rank” element (of the same group of the particular finger). c) the change is relayed to a certain degree 143 to “third-rank” elements of the same group of the particular finger. (A group comprises elements that are generally activated by a specific finger and, for example, form a column such as “X,” “S,” “W,” “2.”)

The horizontal displacement in particular of a second-rank element (e.g. “W”) should also displace a subordinate element (e.g. “2”) so that the direction in which the corresponding finger must extend is maintained (here, for example, a moderately proportioned amplification factor is sufficient). The vertical displacement of a second-rank element should also displace a subordinate element in order to retain the distances between the elements.

3.) “Third-rank” input elements.

If a “third-rank” input element from row 113 is activated primarily (FIG. 3), this primary vector results in: a) the position of this element in terms of the vector being changed, which is calculated as a change (secondary vector) compared with the position of the corresponding “first-rank” element (of the same group of the particular finger). b) initially no or only a relatively small change is relayed to the corresponding “first-rank” element (of the same group of the particular finger). c) the change is relayed in a diminished degree to “second-rank” elements of the same group of the particular finger. Specifically, particular horizontal and vertical changes can be dimensioned such that the stretch direction for the appropriate finger is retained.

4.) “Fourth-rank” input elements as in row 114 (FIG. 4) are, for the one part, dependent in their position and demarcation on proximate higher rank elements and, for the other part, are attached at the edges 115 of the input surface. They thus move with specific, proximate higher order elements and can change their size or shape (For example, those are special and control keys such as space, Shift or Return.)

The sequence of some of these evaluations and calculations is optionally conditionally changeable. Vector components in the x-direction of the input surface are calculated differently in many cases and treated differently than vector components in the y-direction of the input surface.

Other applications require somewhat modified priority structures as the case may be, which is similarly in accordance with these concepts. (See below for the use of other currently valid input elements on the steering wheel.)

The evaluation of the relevance or reliability of the primary vectors of a particular finger is generally possible, including determining stress parameters (over a period of time) from repeatedly occurring major deviations or irregularities. In addition, the evaluation of the relevance or reliability of the input elements of the secondary vectors (in the secondary vector field) is important. If high stress parameters occur for an input element, a downgrading of the rank may be expedient, e.g. that is often the case for the input elements of the little finger. Downgrading the rank of an input element also means that the evaluation of the relevance or reliability conveyed in this cross-linking is diminished, and in particular the influence is already decreased within the aforesaid priority structure.

In the case of four or five fingers of the same hand applied simultaneously, their position on the input surface is assigned with a high degree of certainty to the first-rank input elements. The method recognizes that as initialization or as a calibrated rest position, but then omits to relay the corresponding signals to the activated input elements and calculates from this primary vector field in terms of the priority structure a secondary vector field for the input elements of the corresponding hand.

In the case of two or three (or four or five) fingers of the same hand applied simultaneously, in conjunction with other evaluations—in particular via contacts or approaches (e.g. not evaluated as complete activation) of the input surface with palms or fingers—the identity of the two, three, four or five fingers applied can be determined. The method also identifies that as initialization or as a calibrated rest position and calculates from this primary vector field in terms of the priority structure a secondary vector field for the input elements of the corresponding hand.

After identifying the affiliation of a contact (or approach) with an input element (or following its assignment), an evaluation is expedient concerning how relevant or reliable are the primary vector ascertained thereby and the modification determined therefrom of the arrangement (described by secondary or tertiary vectors):

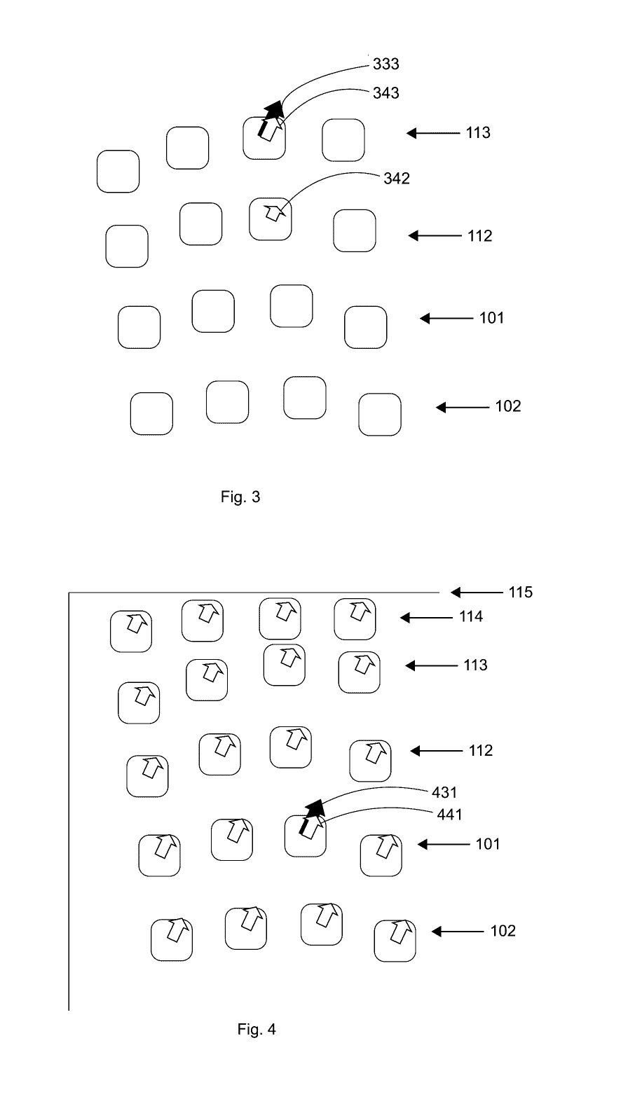

The aforesaid primary vector 132 (or aforesaid vectors of the primary vector field) can be multiplied for the following calculation of secondary vectors as 142 initially using an F-relevance factor that follows from a function that represents an evaluation of the relevance or reliability (of the change described by the vector), where this function is dependent on the distance—writeable as a number or also as a vector—from the ideal center of the input element (virtual key center)—assigned to a particular vector. This “relevance or reliability function” should generally become ultimately smaller for increasing distances from the ideal center (see FIG. 2).

With a specific functional progression over the distance from the ideal key center, a distribution results for the valid F-relevance factor in each case across the points of the input surface. This distribution is, as it were, a relevance or “reliability potential.” (Generally: Potential field across the input surface means that a value, or a factor, is assigned to each point of the input surface.) The aforesaid function can, to this extent, also be dependent on a distance writeable as a vector, can thus be different depending on direction and is writeable as (a currently valid) potential field across the input surface. Reliability function and potential can in addition specifically depend on a (virtual or visually represented) form of the particular input element (e.g. visible key shape, distinguishable against the background): Touching the virtual key corresponds to a greater relevance and reliability than touching the background. The aforesaid function can also consist of one or more jump functions.

A high reliability potential, meaning great relevance and reliable reproducibility of the position identified relative to the ideal key center can be represented in this step of the calculation by an F-relevance factor=1.0, for example. That is the case, for example, with a contact close to the ideal center of the key.

With increasing distance from the ideal center of the key, this method initially proposes an increasing displacement (secondary vector field displacement and high factor), beyond a certain distance this contact (or approach) loses relevance, reliability and reproducibility so that the functional progression decreases (reduced factor) and beyond a certain position (described in the system of input elements by the shape of the virtual key, among other things) even decreases very markedly.

The potential distributions over the input surface described by these functions are, for example, visually representable as height distribution: from each input element or from each virtual key or from each ideal center of a virtual key (meaning from each currently valid input surface area with an ideal center) there proceeds an initially high potential that, for example, can be represented visually as a contour line model or hypsometric model, or can be approximately suggested. So it can be comprehended visually by the user, similar to topography or a landscape, and shows, for example, grey scales or color-graduated surfaces or a representation with optical effects such as progressions of light and shade on a curvature or reflections from a more or less smooth (virtual) surface. Other factors, function values, potential values or evaluations can also be represented in this way.

A cross-linking of input elements exists in the “secondary vector field” (as a description of the initially only planned modification to the arrangement), i.e. specifically within groups or “clusters” of input elements directly proximate or linked by the priority structure, the following actions are carried out: [0046] Relaying of information about the particular “planned” displacement [0047] Connected thereto, collision tests, collision evaluations, distance evaluations, error or stress evaluations [0048] Coordination of the displacement (of proximate input elements) [0049] Additional evaluations, or problem evaluations, through influencing factors and optimizations.

Stated differently, a cross-linking of input elements exists firstly in the “relaying of an intent to displace” (triggered originally by primary vectors) and secondly with respect to information about vectorially (using vectors) writeable displacements that are tested and evaluated in the relative planned position, and in this respect tests for the possible collision of virtual keys, or descriptions thereof are conducted. Cross-linking means then that proximate, specifically contiguous (or relevantly linked via the priority structure), elements are networked with each other (that is, so to speak, a vector field distortion controlled by priorities).

So it is not a matter of displacing the arrangement of input elements only as a whole or of scaling it only as a whole. It is not a matter of displacing it as a whole as the result of statistical data or only simply displacing individual keys depending on the statistics. Rather it is a matter modifying the characteristics of specific groups or clusters of input elements in their arrangement and realizing selected cross-linkings.

From several sequentially recorded (in particular primary) vectors or (in particular primary) vector fields, trends for complex and specifically even non-linear displacements of the input elements can be determined that are only to be described as a multi-dimensional vector field, that are identified specifically as trends within proximate input elements or specifically as trends for the entire system of input elements or as trends of selected groups of input elements. The complex, non-linear displacements, deformations, distortions of the arrangement and the associated evaluations require the description as a multi-dimensional vector field.

A multi-dimensional vector field (or a corresponding potential field) can thus comprise evaluations such as error messages or error evaluations. The error messages or error evaluations of a particular input element can be passed on to other elements,—with the inclusion of translation factors,—in particular to selected directly proximate elements. Or they can, depending on the rank of the input element within the networked system in terms of the priority structure (or of the priority field) be passed on to further input elements. The system of input elements reacts to this, as the case may be, with changed characteristics.

The observation of the position of input elements (and additional information) offers several possibilities for trend identification, or trend reaction, for instance by direct cross-linking of input elements for small areas, in particular the displacement of one element relative to the base row can be relayed to the proximate keys to a certain degree using cross-linking.

A cross-linking of input elements consists, expressed differently, in the “transmission of an intent to displace” triggered by a primary vector, meaning in a “currently planned displacement,” that is to be designated as a secondary vector starting from the ideal center of an input element (or depending on case distinction of the priority structure, it involves an extensive secondary vector field with intents to displace).

This intent to displace an element E1 (to be interpreted as a secondary vector of E1) is coordinated with the intent to displace an element E2 located nearby (to be interpreted as a secondary vector of E2) and in particular with the intents to displace additional elements that, for example are in the planned direction of the displacements (and where appropriate furthermore coordinated with selected intentions to displace of the entire system or—in an extreme case of a high-grade optimization—with intentions to displace within the entire system).

In addition, the cross-linking of elements consists in the transmission of error messages, error evaluations, stress evaluations that, as it were, can be communicated as a further dimension of the particular vector.

Following coordination of this kind, or in particular collision tests, there follows an optimized displacement that is actually to be performed. On the one hand, the cross-linking of a particular element with its proximate elements can be regarded as sufficient. On the other hand, a better overall result is to be expected with the cross-linking across additional elements or element groups or element clusters that are linked with each other by way of priority structures.

These possibilities thus exist simultaneously: [0060] Cross-linking of elements with proximate elements in the surface [0061] Cross-linking of elements with other elements or element groups or element clusters that are linked to each other via priority structures.

Collision messages, error messages, error-risk evaluations or dissonance or stress characteristics can be determined in different ways. It involves in particular error messages or error-risk evaluations in the primary vector field, the detection of collisions of virtual keys in the secondary “planned” vector field, the detection of excessive or sub-optimal changes, meaning “dissonances” in the secondary “planned” vector field, and the minimization of dissonance or stress characteristics in the tertiary vector field.

Tests can take place from different aspects to analyze and evaluate problem zones in the planned “secondary” vector field. A dissonance or stress characteristic can, for example, be ascertained from differences between a planned secondary displacement and a tertiary displacement that was performed, or from too small or too large distances between the elements, or from too large displacements of individual elements compared with the other elements. A general stress factor for the system can be calculated. With dissonance or stress characteristics that are too high, the user can be requested to intervene. Better, the process reacts autonomously by changing system factors for example.

In the process step from the initially planned “secondary” vector field to the “tertiary” vector field to be implemented, an optimization within the entire arrangement of input elements takes place, with respect to the particular displacements of these input elements (described in the “secondary vector field”) and with respect to related factors and evaluations such as: reliability potentials, in particular from reliability functions, relevance potentials, in particular from relevance functions, collision tests, distance evaluations, error or stress evaluations, stress factors, dissonance values or other evaluations or optimizations. In particular, such factors and evaluations can be calculated here that describe an overall evaluation of the system of input elements. Generally, the optimization should minimize stress factors, dissonance factors, etc. and finally reach an optimum of the whole.

The positions of the input elements actually used can deviate compared with the visually depicted positions of the input elements, in particular to obviate visual distractions through severe displacements or irregularities. A separate calculation of stress characteristics within the vector field can be made for this (or for these deviations) and linked to the priority structure: specifically, it assigns a greater relevance for the visual representation (of the entire system of input elements) to the first-rank input elements, said input elements should show as accurately as possible the position actually used.

Starting from the primary vector field, the secondary vector field is calculated specifically via the aforesaid field of priority structures. The inclusion of error messages, error-risk evaluations, reliability evaluations, collision messages, collision evaluations or dissonance or stress characteristics is in each case generally possible as a value field that, as a particular (vector) or potential field, adds additional dimensions to the (primary or in particular to the secondary or tertiary, as the case may be) vector field, or converts the vector field. I.e. specifically one vector field linked to a potential field (e.g. a potential field of error-risk evaluations or of reliability potential or of trend potential) yields either a similarly structured vector field (e.g. with scalar multiplication) or a higher dimension vector field.

In addition, a (secondary) vector field can be analyzed with respect to its particular changes or salient features that appear within the field: a “gradient,” “derivation”, meaning change in relation to proximate points, or input elements, can be assigned to each point across the input surface or to each input element within the system of input elements: a vector field gradient describes the change of a vector field and is in turn itself a vector field.

Different types of optimizations can be performed in the secondary vector field.

A simplified optimization must be calculated by querying selected, representative changes (or slopes/derivations/gradients) in the values (or vectors or vector field values), in particular between selected first-rank input elements and selected second-rank input elements (i.e. this is simplified compared with the complex calculation of a differential equation system). The methods for variation calculation, e.g. following Runge-Kutta or Galerkin can be simplified for this and be broken down to abbreviated queries, cross-comparison methods or comparative calculations.

This problem can be generally and comprehensively depicted as a differential equation system: A differential equation system (DES) can describe a system, or an arrangement, of networked, coherent variables or elements. Variation calculation methods can then determine an optimized solution as a calculated function or as a set of specific characteristics. Here the arrangement of the input elements can be basically considered as a system. Ideally, two functions can be ascribed to each input element, where, for example, the particular coordinates of the ideal center of an input element serve as variables that are linked to the other variables and features of the system in manifold ways. Functional progressions are also to be included, like the one described above, to evaluate the relevance or reliability potential depending on the distance of an activation from the ideal center of the key. Certain variables are thus dependent on each other, for example, calculations of the positions of lower order input elements can be designated from those of higher order input elements. So a plurality of logical links can be determined with the aid of mathematical equations. In addition, the DES system can contain equations that describe error evaluations, preference factors, and similar. The minimization of a stress factor can also be the goal of the variation calculation or the minimization of selected, special stress factors.

Here the possibility of self-management exists, with which the system can autonomously change the weightings, preferences, and linking factors. For example, by reason of increased stress factors in a special area, such as the keys for the little finger, their succeeding links can be (temporarily) formed to be smaller, because problems originating there encroach on the keys of the “ring finger.” In cases such as this, the system should be flexible and react. A DES system is thus a comprehensive form of description, with which selected aspects or selected groupings of elements can be particularly taken into consideration.

In this way an extensive DES system is created. Methods for variation calculation generally scan differences and gradients within a vector field, examine vector field gradients in order to finally determine a function, or its characteristics, as an optimized solution. It therefore involves evaluating multi-dimensional gradients mathematically, expecting potential/possible or intended/planned differences, and using hypsometric models for example. A gradient describes deviations, or slopes, and in the case of these arrangements is itself ultimately a vector field. Calculations of this kind (e.g. following Runge-Kutta or similar methods or with structures of neuronal networks) can be partially reduced again and concentrated on selected links. The solution calculated generally leads as result to a function that, under specific aspects, attains an optimum (calculation of an optimized arrangement of the keys).

This method can also be limited to a certain part of the elements, by applying other factors for certain elements: specific self-correction of the factors.

In the process step from the initially planned “secondary” vector to the “tertiary” vector to be implemented, self-management of the method may take place, wherein detection of problems with input elements results in the autonomous change of the factors used in the method, even variably depending on the input elements. Self-management of the system uses autonomous detection of problem zones and means autonomous modification of the calculation processes. Detection of problems with individual input elements, perhaps through increased error messages there, stress or dissonance values or locally diminished relevance values results in the autonomous change of the factors or evaluation characteristics used in the method. Self-management can specifically use different factors depending on the input elements.

Several technical solutions for generating tangible, haptic feedback on input surfaces are available in development (e.g. electrostatic methods, generated oscillations). Specifically, input elements such as keys, buttons, etc. become tangible. As a basic principle, position and size of an input element can be experienced haptically. Variably controllable, haptic feedback from the input surface can make the current present arrangement of input elements perceptible, or tangible, in their positions.

Surfaces that themselves do not initially act as a touch- or approach-sensitive input surface, can also serve as an input surface, but touching or approaching which can be identified in a different way, in particular with optics or structure-borne sound (e.g. glass panes, table surfaces). Cameras can be used. Or, using optical methods, an “imaginary” surface that is only a virtual surface, can even be used through gesture-based motions in the air.

In the case of the steering wheel, the method for operation as a computer input device is characterized on the one part in that the aforesaid input elements are arranged on the touch-sensitive surface of the steering wheel (or of a steering wheel segment), thus are distributed three-dimensionally. This means that the grippable surfaces of the steering wheel rim serve as input surfaces. With the steering wheel, it is specifically a matter of enabling simple switch functions or gesture-based controls.

The method in the case of the steering wheel is characterized, on the other hand, in that with the exception of the fingertips, contacts or approaches by additional surfaces of the finger, or the hand, are included in the process: in particular, the contact surfaces of the fingers can also be used to actuate the input surface. They and additional surfaces of the hand also provide important information for recognizing the position of hand and fingers. Contacts or approaches, even of small, fragmented surfaces are assigned as far as possible to particular fingers or hand surfaces, particularly through pattern recognition. For example, small surfaces ranged lengthwise in a typical position, are to be interpreted as fingers and the inner surface of the hand, compared with a large surface (the particular fingers are often identifiable).

Different variants of complete or incomplete gripping of and touching the steering wheel occur here. It should be initially recognized in the process, which variant or category of gripping or touching is present. A categorization of hand position, or of gripping or contacting (or a use category) follows in particular from the above mentioned “primary” hand vector field with a three-dimensional description and from other recognition of certain hand or finger surfaces (for instance, through pattern detection or a comparison with the arrangement of input elements).

Categories of hand position, or of gripping or touching, are specifically: hand and finger surfaces placed largely flat on the input surface (standard position, completely encompassing the steering wheel) hand and finger surfaces incompletely placed, that enclose a curvature, i.e. an air space remains between hand and input surface (a distinction can be made between different types of curvature) hand and finger surfaces incompletely placed, that include twisting the hand (a distinction can be made between different types of twisting), gripping with thumb and forefinger gripping starting from thumb and forefinger with further contacts gripping or touching starting from the ball of the hand gripping or touching out of the air, meaning without previous contact a series of gesture-based controls (see below) (approaches can be included here in addition.)

A use category, and if need be, the corresponding triggering of a character follows from a recognized category of this kind of hand position, or gripping or touching—if not already specified. With a steering wheel, a first “level” (see below) initially comprises certain preset, accepted actuations and gesture-based controls.

In many cases, the identity of the active finger plays a part. An identity structure (expressed more precisely: “identity assignation structure”) comprises certain decisions about identity assignations for the fingers that facilitate the processing of the contacts or approaches within certain (preset or identified) use categories: certain identity assignations or a coordinated interplay of non-observance or observance of the identity of an active tapping finger (in particular double-clicking or other actuations as well as gesture-based controls) omits unnecessary identification procedures depending on the case, and carries out an effective assignation to the character communicated by the control unit. This can be specifically be dependent on (not only the use category but also) the currently valid level (see below), or be used precisely to control the level. For example: a single small contacted surface is interpreted as contact of an index finger if no other contacts take place in the vicinity. In particular, a double-click on the first level is interpreted as a double-click of the index finger (if it is not identified as another finger, for instance as a thumb). Two small contacted surfaces (on adjacent circular segments of the torus) are interpreted as two adjacent fingers, specifically as index finger and middle finger, if no other contacts take place in the vicinity.

On the steering wheel it is generally also possible to distinguish, without detailed pattern recognition, based on the contacts with the individual areas of the input surface on the steering wheel rim (left-right, front side-back side) the actuations of the left hand from those of the right hand and additionally to distinguish the actuations of the respective thumb from the actuations of the other fingers. [0101] With this, a tip of a thumb in particular can be identified that is carrying out a gesture-based displacement for example (see also below).

It is expedient for use specifically on the steering wheel, but not limited to this case, to install different “levels” as coordinated planes of use categories that regulate access to trigger characters and functions. Thus different levels of possible characters or switching options, or use categories, structure the particular accepted hand activities so that a plausible distinction exists between intentional actuation compared with an incidental contact:

On the first level individual direct controls (in particular for the vehicle, high beam for example) and the selection and activation of the areas of the second level, such as navigation, radio, telephone, infotainment, media player, etc., are possible with only a few accepted actuations or gesture-based controls. In addition, the general opening of the interaction can be agreed upon, for example by simultaneous double-clicking of both thumbs (because it is extremely unlikely that that happens with the hand movements used for driving). On the first level then, only individual specific use categories, or methods of actuation, are accepted (in particular, for example, double-clicking with a certain number of fingers) that on the one hand switch direct (vehicle) functions (e.g. double-clicking with one finger of the right hand actuates the right directional indicator) or on the other activate, or open, the areas of the next level (e.g. double-clicking with two fingers of the right hand opens navigation, double-clicking with three fingers of the right hand opens the telephone, etc.). On the then activated second level more extensive, more varied use categories, or methods of activation, are accepted (e.g. tapping with fingers identified as middle finger, ring finger, little finger and varied gestures, e.g. for telephone calls, radio station selection or volume control; for example, a double click with four fingers of the left hand opens the third level). On the activated third level (which can also be activated from the first level), the input surface actuations are coordinated with a display (e.g. character entry with cursor movement and clicking on the keyboard displayed), which can use menu structures (e.g. to search in lists) and in particular can operate in the sense of the “10-finger display integration” described below.

(In addition, acoustic coordination or voice control can be integrated here. The second level could optionally be always open or available.)

In other words: on the first level, predetermined use categories, or those to be identified, are to be used, and in fact relatively simple, but compared with normal steering wheel use, distinguishable actuations (accidental activation of input elements is to be excluded in this way), in particular double clicks with a specific number of fingers that do not have to be identified unconditionally as index finger, middle finger, etc. To make matters easier, both the double click of a gripping or resting hand and the double click out of the air (without previous contact with the input surface) can be accepted, or, for example, a simultaneous signal with both hands (or one double click, but only by specific, identified fingers).

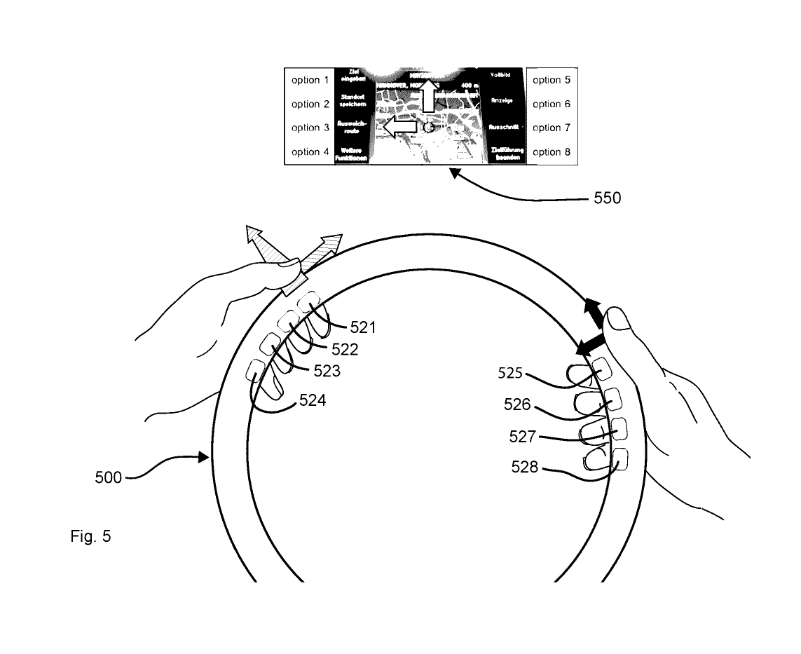

On the first and second levels it is sufficient to operate with the hands without looking, no visual contact with the display is necessary, not even with the input surface, the eyes can remain directed on the road. On the third level, the interactions are coordinated with a display that is located as far as possible in the line of sight, e.g. in display devices arranged above the steering wheel or as a head-up display. Here too, the user does not need to look at his hands or search for switches in order to take hold of them, rather an analogy between his own hands and what is shown on the display allows intuitive operation (see below “10-finger display integration” and FIG. 5). The user can simply operate the input surface through the feeling for the fine-motor movements of his own hands and fingers. Overall, it is a “10-finger input system” that allows the eyes to remain on the road as far as possible.

Base on the particular use category, a suitable priority structure can be selected as required.

The priority structures used in the method described here (and cross-links) can be constructed for the steering wheel, specifically starting from the index finger and thumb, (including finger contact surfaces) and also use the contact surfaces of the inside of the hand as a reference surface with high priority: the first rank should be assigned to the input elements for index finger and thumb (optionally including input elements for the finger contact surfaces), and similarly—depending on the categorization identified—also inner surfaces of the hand (such base of the thumb, base of fingers, balls of the hand), even if they do not act as active input elements in the method, but are included in the process only as “passive” input elements, i.e. even without a switching function their influence on the arrangement of the input elements is taken into consideration as being first-rank (or another rank).

Beyond the fingertips, the finger contact surfaces and the aforesaid contact surfaces of the inside of the hand should, in the case of the steering wheel, be taken into consideration as active or “passive” input elements.

Category identification, identity assignation structure, priority structure (and cross-links used) can also take into consideration and include additional hand and finger positions and gripping variants in the case distinctions of the method. Thus, the only partial grasping of the steering wheel that occurs in three-dimensional gripping of the steering wheel, or only partial contact with the hand, can still be analyzed and included in the method on the basis of indications and of certain partial surfaces identified by pattern recognition or by additional optical methods. Three-dimensional changes in the relation of hand or fingers to the input surface (as distinct from placing them flat) should be identified, categorized, analyzed and taken into consideration. It is important in the case of the steering wheel in particular to identify fingers, phalanges, the areas of the inside surface of the hand where the fingers join (ball of the thumb, base of the fingers) and to identify the directions of the inner surfaces of the hand and their edges and to give them a certain priority (even if they are not needed for the input).

In the case of the steering wheel, the priority structure contains a different definition and sequence of input elements based on use because of other possible categories of gripping variants and case distinctions. Here too, first-rank input elements can have an influence on many, or even all, input elements of a respective hand, second-rank input elements can have an influence on a group of input elements, third-rank input elements influence no or only one or only individual adjacent input elements, and fourth-rank input elements are only influenced by other input elements.

“Passive” input elements can be taken into consideration that generally are not necessarily used to actuate an input (e.g. assigned to inner surfaces of the hand or base of the fingers) but still have an influence in the priority structure.

The arrangements of input elements can—depending on a predetermined or identified use category—comprise simple switches, various keyboards and selectable arrangements with specific clusters and proximate relationships, e.g. telephone keypad, a number of keys set in a row or individual virtual keys in a specific relation to fingertips or hand surfaces, alphanumeric keypad. To this extent, the priority structures and cross-links within the arrangement of input elements relating to each other are to be constructed in different variants (and updated as necessary as a “secondary” or “tertiary” vector field).

Swiping a fingertip on the input surface for cursor control or for scrolling is to be interpreted a) as a “primary” vector and finally b) as displacement of the input element that is positioned under the fingertip, or is defined there. The system of input elements can thereby be determined in the updated positions.

The input elements can be actuated but also be displaced by gestures or re-determined in a new position, e.g. by open tapping without prior contact with the input surface. Displacing or re-determining input elements in this way corresponds to gesture-based control to regulate functions (an actuated input element in conjunction with category identification, opens, as it were, the option of gesture-based regulation). Where appropriate, an open double click, for example, corresponds to the re-determination of input elements—immediately followed by renewed contact and actuation of the same. The application on the steering wheel can thus also contain gesture-based controls. Generally, it is possible within the methods described previously, e.g. starting from the aforesaid, identified and defined input elements, to perform a gesture-based control. Or a contact with subsequent movement is interpreted as a displacement of input elements (thereby newly determined as the case may be). The use of many a “gesture” results in substantial displacement of input elements. (Even independently of the methods described here, many of the gesture-based controls at the steering wheel identified below are possible. Integration into the method described previously certainly offers advantages, such as increased reliability and that even following a “gesture” the networked input elements are immediately in an identified, defined position again.) Many of the gesture-based controls mentioned here are specifically possible only through the special shape of the steering wheel. Examples of gesture-based control at the steering wheel are: cursor control by swiping (in two coordinates) with a fingertip displacing or zooming an object by swiping with one or two fingers control by expanding or contracting (as with a pinching motion) with four (or five) fingertips control by wiping or swiping the index finger and thumb control or scaling of a control variable depending on the distance over which wiping/stroking/swiping is performed. That can extend considerably beyond the distances of normal gestures because the circumference of the steering wheel makes a large distance possible. A positioned finger can be interpreted as the starting point of a gesture-based control if it subsequently performs a “wipe” to control a function, such as the scaling of volume for instance or a firm and yet simultaneously finely differentiated scroll function. In addition, a distinction can made in particular for such a scroll function whether the sliding begins on the top of the steering wheel (meaning with a horizontal motion with a specific number of fingers), then it can produce horizontal scrolling, or whether it begins on the side of the steering wheel (meaning with a vertical motion), then it can produce vertical scrolling. Correspondingly, finely differentiated cursor controls are also possible. It is also possible by placing two hands to designate an area in advance between two positions that are considered to be the maximum and minimum of the scaling and then to swipe within this area. Or swiping with one hand or its fingers can also be performed starting from a firmly held other hand or its fingers. In this way, these gestures can set themselves apart from other contacts. Control by rotation around the inner axis of the gripped steering wheel rim, with index finger and thumb in particular formed into a ring around the steering wheel, meaning by rotation about the steering wheel rim by individual fingers, specifically simultaneously with thumb and index finger like the turning of an adjusting screw, as if a ring on the steering wheel were being turned. Control by rotation around the inner axis of the gripped steering wheel rim, with three or four fingers in particular formed into a ring around the steering wheel or control by rotation around the inner axis of the gripped steering wheel rim with the entire hand specifically formed into a sleeve around the steering wheel. Control by sliding fingers along the steering wheel, in particular with the index finger and thumb formed into a ring around the steering wheel. Triggering a signal by pressing the steering wheel with all the fingers or the entire hand.

Coordination with the method of presentation of a display 550 is expedient for hands holding the steering wheel 500 (FIG. 5): the actuation of input elements 521, 522, 523, 524 and 525, 526, 527, 528 on the input surface by one of the four (or five) identifiable fingers of the left hand or the four (or five) identifiable fingers of the right hand is assigned in a display 550 to four (or five) visible switch options on the left and four (or five) visible switch options on the right, respectively. Thus, for example, the actuation by the left index finger triggers the switch option, or control function, that is shown in the display at the top left as one of the four options. The additional options assigned to the left fingers are show below it on the left edge of the display. Specifically, four switch options should be shown at any one time on the left and right edges of the display. This allows direct actuation of eight (or more) switch options, even without removing the hand from the steering wheel from a gripping position, without changing one's grip. (FIG. 5)

Stated differently, the assignment of characters (or control characters or switch options) to an input element assigned to a particular finger is shown in a display such that the analogy between individual fingers and individual options displayed (characters or control characters or switch options) becomes visible. This analogy can also contain additional hand surfaces or methods of actuation, such as pressing with the inside of the hand or gestured-based controls, in particular swiping. The option of swiping with the index finger, for example, can be indicated in the display by an arrow on which the corresponding currently available switch option is described and begins where the option for (simple) actuation with the index finger is displayed.

The input elements or possible gesture-based controls assigned to the respective hand surfaces or fingers form a geometric arrangement and are shown in a display as characters or switch options to be activated with hands or fingers in such a way that a (partial geometric) analogy between arrangements in the display is visible. Thus optical elements are arranged visibly in the display in a partial analogy to the user's hands.

So the geometric arrangement of the hand surfaces, or fingers, is repeated analogously in the geometric arrangement of the corresponding input elements, or characters (or options to be activated), or in visually comprehensible elements, at least in the sequence and as far as possible also in an additional dimension.

This means specifically that the (input elements or) characters or switching options assigned to the four fingers of the left and the four fingers of the right hand for actuating are shown in the display as four elements or options at the left edge and four elements or options at the right edge. Generally, this is achieved by the input elements that can be reached directly from a hand position or directly possible gesture-based controls being visible in the display with the characters or switching options currently valid for them in their analogy to the arrangement of the hand or the fingers.

These possibilities of actuation, or switching options, by four fingers of the left and right hand respectively in combination with a display that shows the correspondingly available switching options, or characters, arranged in an analogy to the hand of the user, together with the possibility of using one thumb tip using displacement (on the input surface) for scrolling the display content and the other thumb tip using displacement (on the input surface) for cursor control in the display, offer a highly optimized, intuitive, interactive input device, specifically in the form of the steering wheel (FIG. 5), with all 10 fingers fully employed. This “10-finger display integration” combines the contacts and approaches of an input surface with corresponding visuals of a display that are coordinated with the actuation potential of the hands and allows direct control of these switching options correlated to the hands without removing the hands from the wheel.

This (8 or) “10-finger display integration,” additionally combined with the concept described previously of “levels” as coordinated stages of use categories, yields, through the coordination of hand activities, use categories and a visual display method, an optimized (8 or) “10-finger input system” that carries out multiple controls and still allows keeping one's eyes mostly on the road.

Expressed differently, it means that the input elements or possible gesture-based controls assigned to the respective hand surfaces or fingers—forming an arrangement—are depicted in a display as a partially analog arrangement represented by the respective characters or switching options assigned to said elements or controls; thus a partial analogy to the user's hand is visible there so that the input elements directly accessible from a hand position or gesture-based controls directly possible with the currently valid characters or switching options are visible in the display in an analogy to the arrangement of the hand or the fingers; specifically it means that the characters or switching options assigned as analogs to the four fingers of the left hand and the four fingers of the right hand for actuation are shown in the display as four elements at the left edge and four elements at the right edge. As an option, different stages (as explained previously as “levels”) of possible characters or switching options, or use categories, additionally structure the particular accepted hand activities (or use categories) and are coordinated with the use of the display.

Four input elements under the fingertips of one hand (as touch zones aligned in a row) are (essentially) regarded here as a use category, for their “four-fingers priority structure”, see below. In addition, actuations of extended fingers can be differentiated from actuations of bent fingers, or actuations by fingertips from actuations by first and second finger phalanges, thus, for example, 4 times 4=16 switching options are possible. In addition, options of gestured-based sliding (of input elements) may also be possible. The priority structure in these cases should emanate from the positions of the extended fingers (index finger and middle finger).

Generally, “primary” vectors (of respectively actuated, activated input elements) are used to be relayed to the input elements in the logic of the respective priority structure applying to this use category after multiplication with influencing factors (such as F-relevance depending on the “relevance function”) (as “planned secondary” vectors or, depending on the case, as additionally coordinated “tertiary” vectors, for example, via influencing factors from the potential fields or via other influencing vectors).

A “4-finger priority structure” in particular is expedient for the use category of four input elements under the fingertips of one hand (as simple touch zones) that provides a maximum influence on the other input elements for the input elements under the index finger and middle finger. Actuation of the input elements under the ring finger and little finger is relayed in this priority structure with only a minor influencing factor (or the little finger should have scarcely any influence). Here it is expedient to additionally assign “passive” input elements to the areas under the hand inner surface, in particular in the area of the base of the fingers: the “primary” vectors of these input elements provide important indications of the hand position and hand attitude, or gripping attitude, and should be accorded an influence within the four-finger priority structure (e.g. greater than the influence from ring fingers). Here “passive” means that these input elements are not absolutely used for actuations (in many instances, however, they are also used for actuations). When changing grip, or a new grasp by a hand, these input elements are re-determined and make it possible to calculate the other elements based on empirical values regarding hand geometry. The supplementary possibility of swiping on the input surface with the tips of the thumbs should assign to the tip of the applied thumb a particular input element that is then displaced by gestures.

The aforesaid methods can be controlled by a corresponding computer program that includes a computer program code which, if it is run by data processing system, enables the data processing system to perform the methods. Or, the computer program code with instructions executable by the computer to perform the method can be saved on a computer-readable medium or be available over data networks.

1. Method for operating a computer input device, with a touch-sensitive or approach-sensitive input surface, an input surface having a plurality of input surface areas or approach areas and a control unit that is coupled to the input surface, wherein a character, specifically a letter, a number or other control character is assigned to a specific input surface area or approach area and is thus represented as an input element within a system of input elements, characterized in that the surface of a steering wheel or steering wheel segment is used as the input surface and when actuating or displacing or re-determining input elements that are interlinked with each other in their positions, algorithms, depending on predetermined or recognized use category or hand position category, variously incorporate the respective recognized changes in position of the actuated or displaced or re-determined input elements in their effect on the entire system of input elements, and a respective character is transmitted, and, as an option, an updated system of input element position is calculated and wherein the input elements assigned to the particular hand surfaces or fingers or possible gesture-based controls—forming an arrangement—are shown in a separate display as a partially analog arrangement, represented by the characters or switching options assigned thereto, so that the currently valid characters or switching options are visible in the display in an analogy to the arrangement of the hand or the fingers.

2. Method for operating a computer input device from claim 1, wherein contacts or approaches to the input surface are identified in their deviation relative to the currently valid arrangement of input elements and are described as at least a corresponding vector—primary vector—or as a field of vectors“primary vector field,”—where a value pair or several values are used as a vector—, and in a process step using algorithms initially only planned respective displacements of the input elements, —described as a field of vectors—“secondary vector field”—are calculated, and a priority structure between the different input elements is used; at least one additional value is assigned as a factor, or a further field, specifically a potential field or a vector field that represents in each case valid factors for the algorithms to the input surface, or to vectors assigned to the aforesaid respective input elements, and in a further process step through case distinctions or co-ordinations or cross-comparison calculations therefrom, the displacements of the respective input elements of the system writeable as a vector field—“tertiary vector field”—are calculated and performed.

3. Method for operating a computer input device from claim 1, wherein contacts or approaches to the input surface are identified in their deviation relative to the currently valid arrangement of input elements and are described as at least a particular vector—“primary vector”—or as a field of vectors—“primary vector field”—and from this the particular planned displacements of the input elements of the system, or those to be carried out, described as a field of vectors“secondary vector field”—are calculated in a process step using algorithms, and in fact via a priority structure that contains case distinctions depending on primarily activated input elements or input elements primarily referred to, and describes rankings and particular links or cross-links between the different input elements.

4. Method for operating a computer input device from claim 3, wherein a priority structure a) includes case distinctions—in particular according to the input element considered primarily affected or according to the primary vector field—, b) serves to describe rankings and links—or cross-links—between the input elements and in particular is writeable via links within a field of input elements, c) is calculated with the primary vector or the primary field of displacement vectors, d) is linked to additional factors that are calculated depending on use or hand position categories, e) and wherein the aforesaid planned secondary vector field is thereby calculated.

5. Method for operating a computer input device from claim 3, wherein aforesaid algorithms use a priority structure that—specifically depending on an input element considered as primarily affected or depending on the primary vector field—uses a set of selectable factors, wherein these factors serve to calculate the planned secondary vector field and thus control the characteristics of the system of input elements.

6. Method for operating a computer input device from claim 3, wherein aforesaid algorithms use a priority structure that contains a ranking of input elements, wherein first-rank input elements have an influence on a plurality of the other, or on all other, displaceable input elements of the system—in particular consisting of input elements for a particular hand—second-rank input elements have an influence on a group of input elements of a system, third-rank input elements affect no, or only one or only individual neighboring input elements, and fourth-rank input elements are influenced only by other input elements.

7. Method for operating a computer input device from claim 3, wherein when four or five fingers of the same hand are positioned simultaneously, the method identifies that as initialization or as a calibrated rest position and calculates from this primary vector field a secondary vector field for the input elements of the corresponding hand in terms of the priority structure.

8. Method for operating a computer input device from claim 3, wherein with the simultaneous placement of two, three, four or five fingers of the same hand in conjunction with other evaluations—in particular through contacts or approaches to the input surface with surfaces of the hand or fingers—the identity of the two, three, four or five fingers placed simultaneously is determined and the method recognizes that as initialization or as a calibrated rest position and calculates from this primary vector field a secondary vector field for the input elements of the corresponding hand in terms of the priority structure.

9. Method for operating a computer input device from claim 1, wherein contacts or approaches to the input surface are described in their deviation relative to the currently valid arrangement of input elements and as at least a particular vector—“primary vector”—or as a field of vectors—“primary vector field”—and from this, in a process step using algorithms, the particular displacements of the input elements of the system planned or to be performed and described as a field of vectors—“secondary vector field”—are calculated, wherein the aforesaid primary vector or aforesaid vectors of the primary vector field are multiplied by a factor that is derived from a function dependent on the distance—which is writeable as a number or as a vector—from the ideal center of the input element assigned to the particular primary vector.

10. Method for operating a computer input device from claim 9, wherein the aforesaid function depends on a distance which is writeable as a vector, is therefore different depending on direction and thus is specifically writeable as a potential field over the input surface and in particular depends on a form of the particular input element.

11. Method for operating a computer input device from claim 1, wherein factors, function values, potential values, vectors or influencing factors that are to be assigned to the respective points of the input surface or particular input elements, are shown visually or indicated, similar to a hypsometric model—or in a similar way, for example gray scales or surfaces graduated in color.

12. Method for operating a computer input device from claim 1, wherein, from several vectors or vector fields plotted in succession, trends for displacements in the arrangement of the input elements are ascertained that are described multi-dimensionally as a vector field and in particular are recognized as trends within groups or “clusters” of the entire system of input elements.

13. Method for operating a computer input device from claim 2, wherein a link or cross-link between input elements—in particular neighboring elements or those linked by the priority structure—takes place, in fact with respect to the initially planned particular displacements of these input elements described in the aforesaid “secondary vector field” and with respect to related collision tests, distance evaluations, error or stress evaluations or other evaluation or optimizations.

14. Method for operating a computer input device from claim 2, wherein in the process step from the initially planned “secondary” vector field to the “third” vector field to be carried out, an optimization takes place within the arrangement of input elements, and in fact with respect to the particular displacements of the input elements, and with respect to connected factors and evaluations, such as reliability potentials, in particular from reliability functions, relevance potentials specifically from relevance functions, collision tests, distance evaluations, error or stress evaluations or other evaluations or optimizations.

15. Method for operating a computer input device from claim 2, wherein self-management of the process occurs, in particular in the process step from the initially planned “secondary” vector field to the “tertiary” vector field to be performed, wherein identifying problems with individual input elements or identifying problem variants or problem categories results in the autonomous change of the factors used in the process that may also be different for particular input elements.

16. Method for operating a computer input device from claim 1, wherein controllable haptic feedback from the input surface is adapted to the current arrangement of the input elements and makes the latter perceptible or tangible in their positions on the input surface.

17. Method for operating a computer input device from claim 1, wherein contacts or approaches to the input surface are identified in their deviation relative to the currently valid arrangement of input elements and are described as at least a particular vector—“primary vector”—or as a field of vectors—“primary vector field”—and from that, in a process step using algorithms, the particular planned displacements of the input elements of the system or those then to be performed described as a field of vectors—“secondary vector field”—are calculated, wherein a further vector field—a “hand vector field”—is included in the process to describe the three-dimensional changes of selected hand and finger surfaces over against the input surface.

18. Method for operating a computer input device from claim 1, wherein the method also considers and includes different hand and finger positions and variants of touching or gripping, in particular an only partial grasp or touch on the steering wheel or contacts or approaches by surfaces of the hand, e.g. finger surfaces and inner hand surfaces.

19. Method for operating a computer input device from claim 1, wherein gesture-based controls on the input surface—to trigger characters or to control selectable functions or to control variables—are symbolized respectively represented by the characters, switching options, selectable functions or controls in the separate display, such as: displacement or zooming of an object shown using a display by swiping using one or two fingers, or cursor control or scrolling by swiping using one finger or the control or scaling of a control variable by expanding or contracting using four or five fingers—as with a pinching motion—or the control or scaling of a control variable depending on the distance over which a wipe or swipe is performed or the control or scaling of a control variable depending on the distance over which it is performed, wherein it is performed with one hand or its fingers starting from another, firmly held hand or its fingers, or the control or scaling of a control variable depending on the distance over which a wipe or swipe is performed, wherein a distinction is additionally made for a scrolling function whether the swipe starts on the top of the steering wheel to effect horizontal scrolling or whether it starts on the side of the steering wheel to effect vertical scrolling, or control by wiping or swiping using the index finger and thumb, or control through the rotation about the inner axis of the gripped steering wheel rim using index finger and thumb—in particular formed into a ring around the steering wheel or control by rotating about the inner axis of the steering wheel rim using three or four fingers—specifically formed into a ring around the steering wheel or control through rotation about the inner axis of the steering wheel using the entire hand—specifically formed into a ring around the steering wheel or swiping fingers along the steering wheel using index finger and thumb—specifically formed into a ring around the steering wheel or triggering a signal by pressing the steering wheel using all the fingers or the entire hand.

20. Method for operating a computer input device from claim 1, wherein the assigned characters or switching options are visible in the separate display as a partial analogy to the user hand, and that the characters or switching options assigned in analog form to a number of fingers of the left and a number of fingers of the right hand for actuation are shown in the display as a number of elements on the left edge and a number of elements on the right edge.
